(19) United States
(12) Patent Application Publication
(10) Pub. No.: US 2025/0253454 A1
(43) Pub. Date: Aug. 7, 2025

(54) LAMINATED BATTERY

(71) Applicant: TOYOTA JIDOSHA KABUSHIKI KAISHA, Toyota-shi (JP)

(72) Inventor: Ryo KAGAMI, Ichinomiya-shi (JP)

(73) Assignee: TOYOTA JIDOSHA KABUSHIKI KAISHA, Toyota-shi (JP)

(21) Appl. No.: 18/986,863

(22) Filed: Dec. 19, 2024

(30) Foreign Application Priority Data
Feb. 6, 2024 (JP) 2024-016409

(51) Int. Cl. H01M 50/184; H01M 50/105; H01M 50/186; H01M 50/531

(52) U.S. Cl. CPC H01M 50/184; H01M 50/105; H01M 50/186; H01M 50/531

(57) ABSTRACT

The present disclosure provides a laminated battery that can reduce the effects of changes in pressure inside the laminate film and/or changes in volume of the electrode stack occurring with charge-discharge of the battery. The laminated battery 1 of the disclosure comprises an electrode stack 10, a current collector terminal 20 disposed on a side section of the electrode stack 10, a current collector part 30 electrically connecting an end of the electrode stack with an end of the current collector terminal, and a laminate film 40 sealing the electrode stack 10 together with the current collector terminal 20. The laminate film 40 in the laminated battery 1 of the disclosure also has a curved section 41 in the region R between the end of the electrode stack and the end of the current collector terminal.

### FIELD

The present disclosure relates to a laminated battery.

### BACKGROUND

Laminated batteries are known which have electrode stacks sealed with laminate films. The pressure inside a laminate film in a laminated battery increases abnormally due to gasification of the components of the electrode stack, for example.

In this regard, PTL 1 discloses a laminated battery wherein, once the internal pressure on the exterior body (laminate film) has increased above a predetermined value, the exterior body ruptures in a stable manner to release the internal pressure.

### CITATION LIST

### Patent Literature

[PTL 1] Japanese Unexamined Patent Publication No. 2022-145145

### SUMMARY

### Technical Problem

It is preferred for the sealed sections of a laminate film to avoid rupture when the pressure inside the laminate film has abnormally increased, so long as the pressure is within an allowable range.

Incidentally, the electrode stack may undergo changes in volume with charge-discharge of the laminated battery, depending on the type of electrode active material used in the battery. Since the interior of the laminate film is sealed, the pressure inside the laminate film varies in response to the change in volume of the electrode stack. In other words, swelling of the electrode stack often causes increase in pressure inside the laminate film, while shrinkage of the electrode stack often causes the pressure inside the laminate film to be lowered.

The present inventors have found that the increase in pressure inside a laminate film that takes place with swelling of the electrode stack can lead to rupture of the sealed sections of the laminate film, and that the electrode stack swelling itself can potentially lead to damage of the laminate film. The present inventors have also found that the lowering of pressure inside a laminate film that takes place with shrinkage of the electrode stack produces tensile stress in the laminate film, resulting in potential rupture of the sealed sections of the laminate film.

It is an object of the present disclosure to provide a laminated battery that can reduce the effects of changes in pressure inside the laminate film and/or changes in volume of the electrode stack occurring with charge-discharge of the battery.

### Solution to Problem

The present inventors have found that this object can be achieved by the following means.

### <Aspect 1>

A laminated battery comprising:
an electrode stack,
a current collector terminal disposed on a side section of the electrode stack,
a current collector part electrically connecting an end of the electrode stack with an end of the current collector terminal, and
a laminate film sealing the electrode stack together with the current collector terminal,
wherein the laminate film has a curved section in the region between the end of the electrode stack and the end of the current collector terminal.

### <Aspect 2>

The laminated battery according to aspect 1, wherein the curved section has a convex part protruding toward the inner side or outer side of the laminate film.

### <Aspect 3>

The laminated battery according to aspect 1 or 2, wherein the ratio of the height of the curved section with respect to the thickness of the thinner of either the electrode stack or current collector terminal is 0.1 or more.

### <Aspect 4>

The laminated battery according to any one of aspects 1 to 3, wherein the distance L from the end of the electrode stack to the end of the current collector terminal is 1 mm or more and 100 mm or less.

### <Aspect 5>

The laminated battery according to any one of aspects 1 to 4, wherein the ratio L/T1 of the distance L from the end of the electrode stack to the end of the current collector terminal with respect to the thickness T1 of the electrode stack is 0.01 or more and 100 or less, and the ratio L/T2 of the distance L from the end of the electrode stack to the end of the current collector terminal with respect to the thickness T2 of the current collector terminal is 0.001 or more and 100 or less.

### Advantageous Effects of Invention

According to the disclosure it is possible to provide a laminated battery that can reduce the effects of changes in pressure inside the laminate film and/or changes in volume of the electrode stack occurring with charge-discharge of the battery.

### BRIEF DESCRIPTION OF DRAWINGS

FIG. 1 is a schematic plan view showing an example of a laminated battery of the disclosure, in overview.

FIG. 2A is a set of simplified cross-sectional views showing an example of a laminated battery of the disclosure, with region R magnified.

FIG. 2B is a set of simplified cross-sectional views showing an example of a laminated battery of the disclosure, with region R magnified.

FIG. 2C is a set of simplified cross-sectional views showing an example of a laminated battery of the disclosure, with region R magnified.

FIG. 3A is a set of simplified cross-sectional views showing an example of a laminated battery of the disclosure, with region R magnified.

FIG. 3B is a set of simplified cross-sectional views showing an example of a laminated battery of the disclosure, with region R magnified.

FIG. 3C is a set of simplified cross-sectional views showing an example of a laminated battery of the disclosure, with region R magnified.

FIG. 4 is a set of simplified cross-sectional views showing an example of a laminated battery of the disclosure, with region R magnified.

FIG. 5A is a simplified cross-sectional view illustrating the function of the laminated battery of the disclosure.

FIG. 5B is a simplified cross-sectional view illustrating the function of the laminated battery of the disclosure.

FIG. 6A is a simplified cross-sectional view corresponding to FIG. 5A for a laminated battery of the prior art.

FIG. 6B is a simplified cross-sectional view corresponding to FIG. 5B for a laminated battery of the prior art.

### DESCRIPTION OF EMBODIMENTS

An embodiment of the disclosure will now be described in detail with reference to the accompanying drawings. The disclosure is not limited to the embodiment described below, however, and various modifications may be implemented which do not depart from the gist thereof. The dimensional relationships in the drawings do not reflect actual dimensional relationships.

### <Laminated Battery>

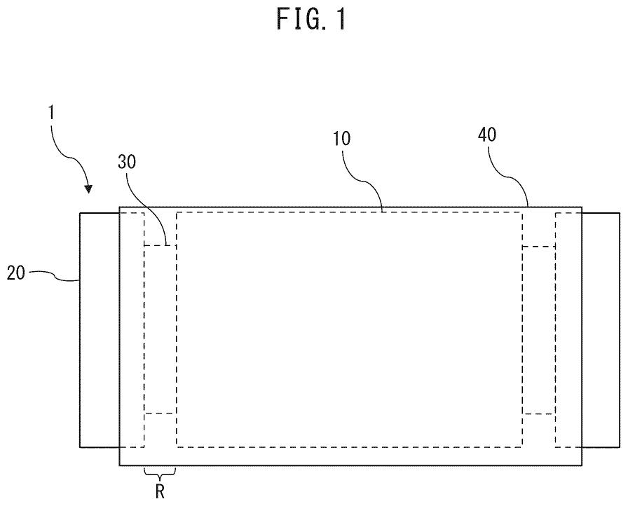

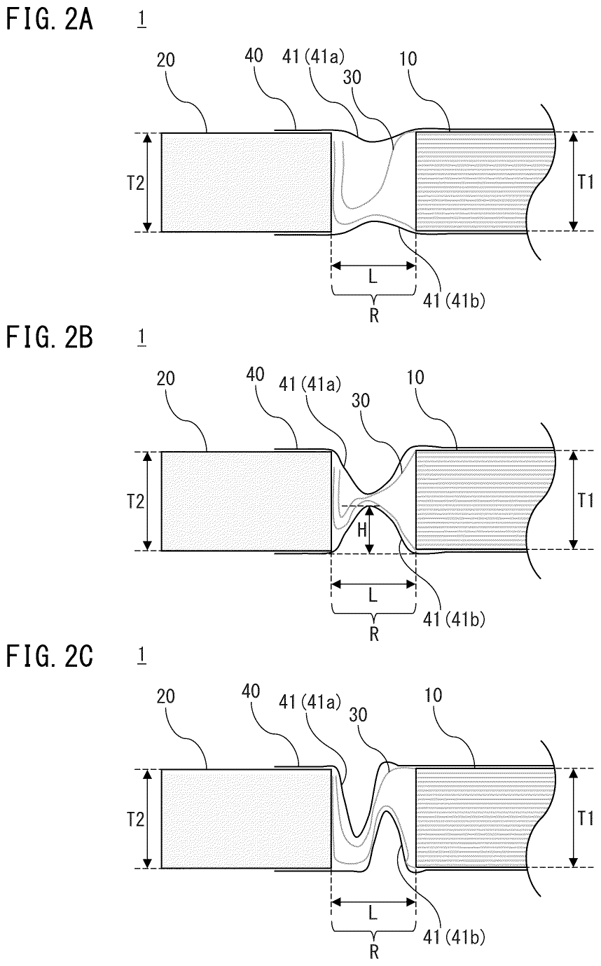

As exemplified in FIG. 1, the laminated battery 1 of the disclosure (also referred to as “pouch battery”) comprises an electrode stack 10, a current collector terminal 20 disposed on a side section of the electrode stack 10, a current collector part 30 electrically connecting an end of the electrode stack with an end of the current collector terminal, and a laminate film 40 sealing the electrode stack 10 together with the current collector terminal 20. As exemplified in FIGS. 2 (2A to 2C) to 4, the laminate film 40 in the laminated battery 1 of the disclosure also has a curved section 41 in the region R between the end of the electrode stack and the end of the current collector terminal.

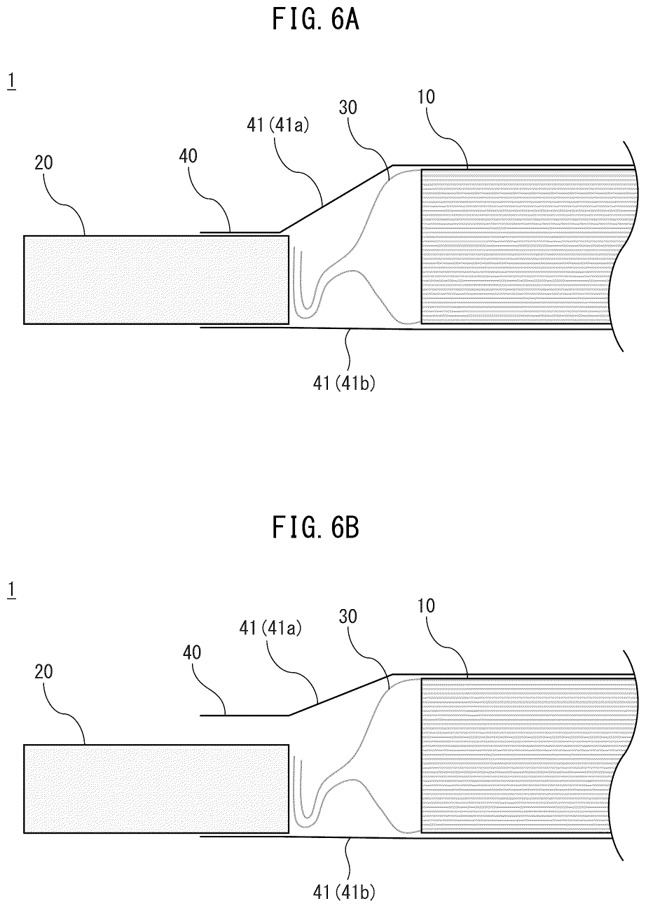

The present inventors considered that one reason that a laminated battery is unable to reduce the effects of changes in pressure inside the laminate film and/or of changes in volume of the electrode stack that occur with charge-discharge of the battery, is that the laminate film has no excess length in the region between the end of the electrode stack and the end of the current collector terminal, i.e. the region where it is neither contacted with the electrode stack or the current collector terminal, as exemplified in FIGS. 6A and 6B. When the pressure inside the laminate film increases, for example, as exemplified in FIG. 6B, the sealed section of the laminate film (the seal section between the laminate film and current collector terminal in FIG. 6B) may rupture.

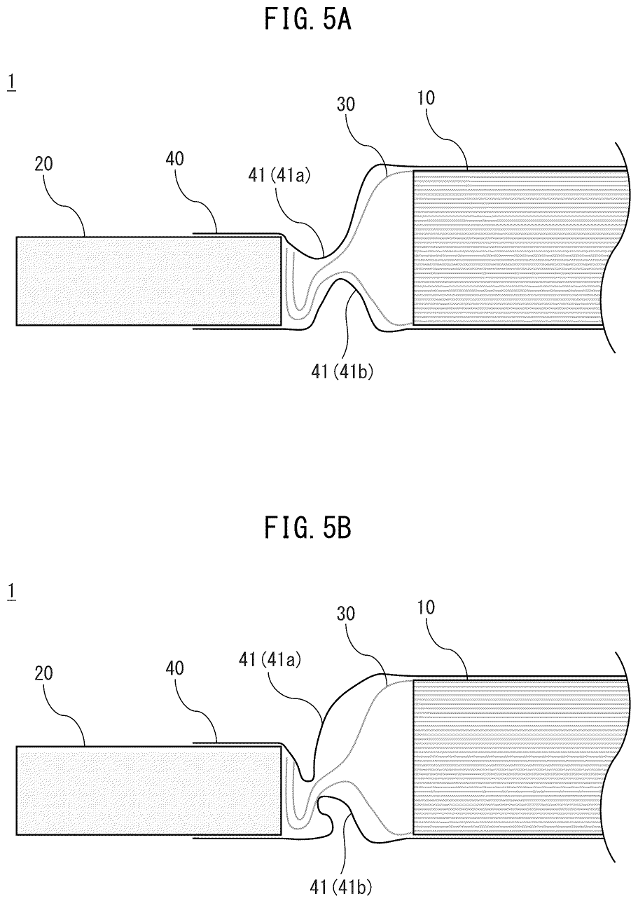

In this regard, the present inventors found that by forming a curved section 41 in the region R between the end of the electrode stack and the end of the current collector terminal in the laminate film 40, it is possible to reduce the effects of changes in pressure inside the laminate film and/or of changes in volume of the electrode stack that occur with charge-discharge of the battery. The reason for this is thought to be that since the laminate film 40 has excess length in the region R, thus having a curved section 41 as exemplified in FIG. 5A, the laminate film 40 deforms to collapse the space formed by the curved section 41, thereby increasing the volume in the space inside the laminate film, as exemplified in FIG. 5B, even when the pressure inside the laminate film has increased, for example. It is thought that this can reduce the effects of changes in pressure inside the laminate film and/or of changes in volume of the electrode stack that occur with charge-discharge of the battery.

Regarding to the disclosure, Damage to a laminate film, includes, for example, damage caused by increasing pressure applied from the electrode stack onto the laminate film at the sides and angles of contact between the electrode stack and the laminate film due to swelling of the electrode stack.

The laminated battery 1 of the disclosure comprises an electrode stack 10, a current collector terminal 20 disposed on a side section of the electrode stack 10, a current collector part 30 electrically connecting an end of the electrode stack with an end of the current collector terminal, and a laminate film 40 that seals the electrode stack 10 together with the current collector terminal 20. Regarding to the disclosure, the “end of the electrode stack” is the end among the ends of the electrode stack that faces the current collector terminal. Likewise, the “end of the current collector terminal” is the end among the ends of the current collector terminal that faces the electrode stack.

The laminate film 40 in the laminated battery 1 of the disclosure has a curved section 41 in the region R between the end of the electrode stack and the end of the current collector terminal.

There are no particular restrictions on the shape of the curved section 41. As exemplified in FIGS. 2 (2A to 2C) and 3 (3A to 3C), the curved section 41 has a convex part that protrudes toward the inner side of the laminate film 40. With this type of construction it is possible to reduce increase in thickness of the laminated battery 1 of the disclosure, thus allowing multiple laminated batteries 1 to be bundled into a stack, so as to prevent the curved section 41 from interfering with pressure equalization of the laminated battery 1 when a battery module has been formed.

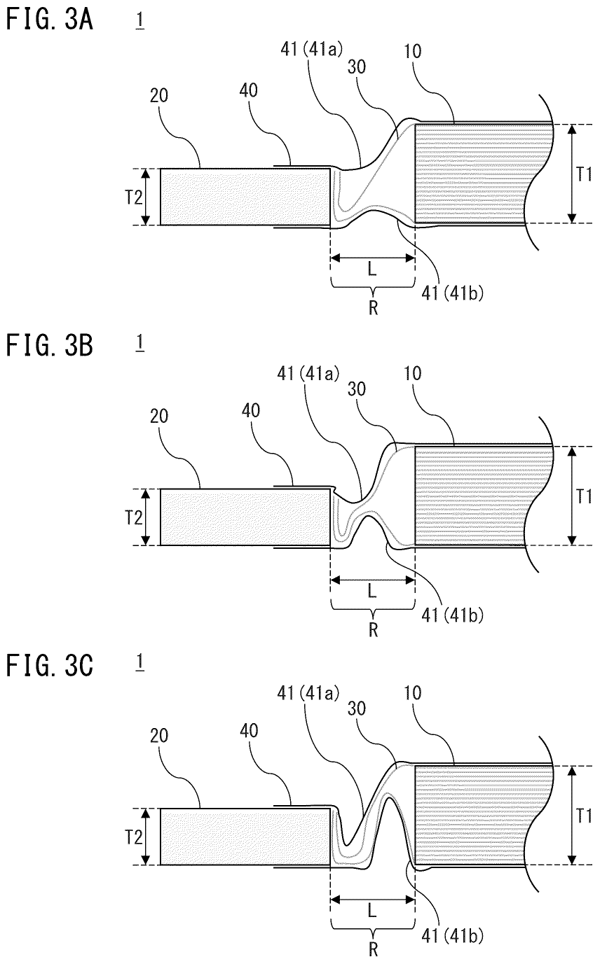

FIGS. 2A to 2C are a simplified cross-sectional view showing an example of the shape of a curved section 41 where the thickness of the electrode stack 10 and the thickness of the current collector terminal 20 are the same. FIGS. 3A to 3C are a simplified cross-sectional view showing an example of the shape of a curved section 41 where the thickness of the current collector terminal 20 is smaller than the thickness of the electrode stack 10.

There are no particular restrictions on the method of forming the curved section 41 which has a convex part that protrudes toward the inner side of the laminate film 40. For example, it may be a method of forming a curved shape in the laminate film 40 beforehand, or a method of curving the laminate film 40 while sealing under reduced pressure when sealing the electrode stack 10 with the laminate film 40.

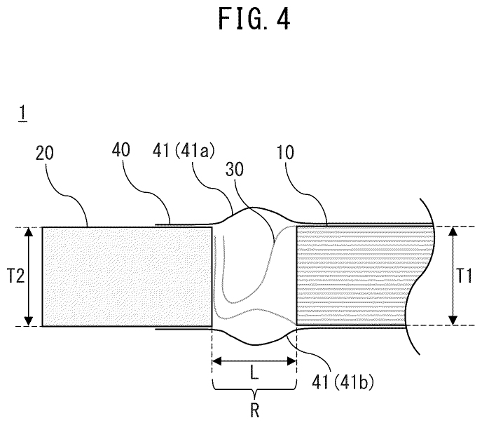

The curved section 41 may also have a convex part that protrudes toward the outer side of the laminate film 40, as exemplified in FIG. 4. Such a construction will help reduce the effects of lower pressure inside the laminate film and/or shrinkage of the electrode stack that occurs with discharge of the battery.

There are no particular restrictions on the method of forming the curved section 41 which has a convex part that protrudes toward the outer side of the laminate film 40. For example, it may be a method of forming a curved shape in the laminate film 40 beforehand, or a method of curving by pushing in the current collector terminal 20 toward the electrode stack 10 after the electrode stack 10 has been sealed with the laminate film 40 and current collector terminal 20.

When the curved section 41 has a convex part that protrudes toward the inner side or outer side of the laminate film 40, the convex part of the curved section 41 may be formed at a location near the middle of the distance L from the end of the electrode stack to the end of the current collector terminal. Such a construction will help prevent interference between the laminate film and the electrode stack and current collector terminal, even with changes in pressure inside the laminate film and/or changes in volume of the electrode stack that occurs with charge-discharge of the battery.

The laminate film 40 may have the curved section 41 either on the top side or the bottom side in the thickness direction of the electrode stack 10, or it may have the curved section 41 on both the top side and bottom side in the thickness direction of the electrode stack 10. The curved section on the top side may be referred to as 41a, and the curved section on the bottom side may be referred to as 41b.

The ratio of the height H (mm) of the curved section with respect to the thickness (mm) of the thinner of either the electrode stack 10 and current collector terminal 20 may be 0.1 or more. For example, when the thickness T2 of the current collector terminal is thinner than the thickness T1 of the electrode stack, the ratio is expressed as H/T2. The ratio may be 0.2 or more, 0.3 or more, 0.4 or more, 0.5 or more, 0.6 or more or 0.7 or more, and 1.0 or less, 0.9 or less, 0.8 or less, 0.7 or less, 0.6 or less, 0.5 or less or 0.4 or less. A high ratio can effectively reduce the effects of large changes in pressure inside the laminate film and/or changes in volume of the electrode stack that occur with charge-discharge of the battery. A low ratio will help eliminate any excess risk of damage to the current collector part 30 by contact between the laminate film and current collector part, allowing the curved section 41 to be formed more easily.

The height H of the curved section is the shortest distance from an imaginary straight line connecting the shortest distance between the lower side forming the end of the electrode stack and the lower side forming the end of the current collector terminal, to the apex of the convex part of the curved section 41b on the bottom side (see FIG. 2B), or the shortest distance from an imaginary straight line connecting the shortest distance between the upper side forming the end of the electrode stack and the upper side forming the end of the current collector terminal, to the apex of the convex part of the curved section 41a on the top side, in the laminate film.

When curved sections 41a and 41b are on both the top side and bottom side in the thickness direction of the electrode stack 10, and the relationship is: thickness T1 of electrode stack=thickness T2 of current collector terminal, the relationship may be: height of curved section 41a=height of curved section 41b, as exemplified in FIGS. 2A to 2C.

When curved sections 41a and 41b are on both the top side and bottom side in the thickness direction of the electrode stack 10, the positions of the electrode stack and current collector terminal are in the relationship exemplified in FIGS. 3A to 3C, and the relationship is: thickness T1 of electrode stack>thickness T2 of current collector terminal, the relationship may be: height of curved section 41a<height of curved section 41b. For such a construction, the curved section 41b may be formed on the electrode stack 10 side and the curved section 41a may be formed on the current collector terminal 20 side.

The distance L from the end of the electrode stack to the end of the current collector terminal may be 1 mm or more and 100 mm or less. The distance L may also be 2 mm or more, 5 mm or more or 10 mm or more, and 50 mm or less, 25 mm or less or 10 mm or less. If the distance L is within this range, it will be easier to form the curved section 41, and easier to obtain the effect of the disclosure of reducing the effects of changes in pressure inside the laminate film and/or changes in volume of the electrode stack that occur with charge-discharge of the battery.

The ratio L/T1 of the distance L from the end of the electrode stack to the end of the current collector terminal with respect to the thickness T1 of the electrode stack may be 0.01 or more and 100 or less, and the ratio L/T2 of the distance L from the end of the electrode stack to the end of the current collector terminal with respect to the thickness T2 of the current collector terminal may be 0.001 or more and 100 or less. The ratio L/T1 may be 0.1 or more, 0.5 or more or 1 or more, and 50 or less, 25 or less, 10 or less, 5 or less or 1 or less. The ratio L/T2 may be 0.01 or more, 0.05 or more or 0.1 or more, and 10 or less, 5 or less, 1 or less, 0.5 or less or 0.1 or less. If these ratios are within the aforementioned ranges, it will be easier to form the curved section 41, and easier to obtain the effect of the disclosure of reducing the effects of changes in pressure inside the laminate film and/or changes in volume of the electrode stack that occur with charge-discharge of the battery.

The thickness T1 of the electrode stack may be 1 mm or more, 2 mm or more, 5 mm or more or 10 mm or more, and 100 mm or less, 50 mm or less, 25 mm or less or 10 mm or less, for example.

The ratio T2/T1, as the thickness T2 of the current collector terminal with respect to the thickness T1 of the electrode stack, may be 0.1 or more, 0.3 or more, 0.5 or more, 0.6 or more, 0.7 or more or 0.8 or more, and 1 or less, 0.9 or less, 0.8 or less, 0.7 or less, 0.6 or less or 0.5 or less.

The laminated battery of the disclosure was described above assuming a mode in which the laminate film has a curved section in the direction of stacking of the electrode stack, but the location of forming the curved section is not particularly restricted. For example, the laminate film may have the curved section in the in-plane direction of the electrode stack.

The elements composing the laminated battery of the disclosure will now be described.

### <Electrode Stack>

The electrode stack 10 functions as a power generating element in the laminated battery 1. The shape of the electrode stack 10 is not particularly restricted, and for example, it may have a top side section, a bottom facing the top side section, and four side sections connecting the top side section and bottom side section. The shape of the top side section is also not particularly restricted, and for example, it may be quadrilateral, such as square, rectangular, rhomboid, trapezoid or parallelogram-shaped. The shape of the top side section may also be a polygonal shape other than quadrilateral, or it may be a shape having curves, such as circular. The shape of the bottom side section is the same shape as the top side section. The shapes of the side sections are also not particularly restricted, and for example, they may be quadrilateral, such as square, rectangular, rhomboid, trapezoid or parallelogram-shaped.

The electrode stack 10 may have a negative electrode current collector, negative electrode active material layer, electrolyte layer, positive electrode active material layer and positive electrode current collector, in that order.

### <Current Collector Terminal>

The current collector terminal 20 is disposed on a side section of the electrode stack 10. The current collector terminal 20 may also be disposed on a pair of side sections facing the electrode stack 10. In this case, the laminated battery 1 will have two regions R between the end of the electrode stack and end of the current collector terminal of the laminate film 40. According to this aspect, the laminate film 40 may have a curved section 41 on one of the two regions R, or it may have curved sections 41 on both.

The material of the current collector terminal 20 is not particularly restricted so long as it is a material with a current collection function, and for example, it may be the same metal material as the positive electrode current collector and negative electrode current collector.

### <Current Collector Part>

The current collector part 30 electrically connects the end of the electrode stack with the end of the current collector terminal. The current collector part 30 may be a bundle of sections of the positive electrode current collectors of the electrode stack 10 where the other layers are not laminated, or it may be a bundle of sections of the negative electrode current collectors of the electrode stack 10 where the other layers are not laminated.

### <Laminate Film>

The laminate film 40 seals the electrode stack 10, together with the current collector terminal 20. The laminate film may have a sealant resin layer, a metal layer and a protective resin layer, in that order along the thickness direction.

Examples of materials for the sealant resin layer include olefin-based resins such as polypropylene (PP) and polyethylene (PE). Examples of materials for the metal layer include aluminum, aluminum alloy and stainless steel. Examples of materials for the protective resin layer include polyethylene terephthalate (PET) and nylon.

The thickness of the sealant resin layer is 40 μm to 100 μm, for example. The thickness of the metal layer is 30 μm to 60 μm, for example. The thickness of the protective resin layer is 20 μm to 60 μm, for example. The thickness of the laminate film is 80 μm to 250 μm, for example.

### REFERENCE SIGNS LIST

1 Laminated battery
10 Electrode stack
20 Current collector terminal
30 Current collector part
40 Laminate film
41 Curved section

1. A laminated battery comprising:
an electrode stack,
a current collector terminal disposed on a side section of the electrode stack,
a current collector part electrically connecting an end of the electrode stack with an end of the current collector terminal, and
a laminate film sealing the electrode stack together with the current collector terminal,
wherein the laminate film has a curved section in the region between the end of the electrode stack and the end of the current collector terminal.

2. The laminated battery according to claim 1, wherein the curved section has a convex part protruding toward the inner side or outer side of the laminate film.

3. The laminated battery according to claim 1, wherein the ratio of the height of the curved section with respect to the thickness of the thinner of either the electrode stack or current collector terminal is 0.1 or more.

4. The laminated battery according to claim 1, wherein the distance L from the end of the electrode stack to the end of the current collector terminal is 1 mm or more and 100 mm or less.

5. The laminated battery according to claim 1, wherein the ratio L/T1 of the distance L from the end of the electrode stack to the end of the current collector terminal with respect to the thickness T1 of the electrode stack is 0.01 or more and 100 or less, and the ratio L/T2 of the distance L from the end of the electrode stack to the end of the current collector terminal with respect to the thickness T2 of the current collector terminal is 0.001 or more and 100 or less.
